(19) United States
(12) Patent Application Publication
(10) Pub. No.: US 2002/0003867 A1
(43) Pub. Date: Jan. 10, 2002

(54) Systems and methods for connecting customers to merchants over a voice communication network

(76) Inventors: Peter Rothschild, Newton, MA (US); Robert LaChance, Cambridge, MA (US)

Correspondence Address: Patent Group, Foley, Hoag & Eliot LLP, One Post Office Square, Boston, MA, 02109-2170, US

(21) Appl. No.: 09/839,586

(22) Filed: Apr. 20, 2001

Related U.S. Application Data
(60) Provisional application No. 60/198,642, filed on Apr. 20, 2000.

(51) Int. Cl. H04M 1/64

(52) U.S. Cl. 379/88.01

(57) ABSTRACT

Systems and methods capable of communication with a caller over a voice communication channel. The systems and methods allow a customer to employ a telephone to dial a telephone number that connects them with a central server. The server operates a voice recognition process that presents the customer with a computer-generated voice menu of options—for example, grocery delivery, takeout food, taxicabs, or information services. The caller would then say “food.” They would then say the location of their home after being prompted by the server system. After hearing a list of food options, the caller may select a choice by saying for example “Chinese”. The system would then present them with a list of restaurants to choose from. The caller would say the name of the restaurant of their choice, and the system would then route the call directly to the restaurant. The caller could equally well have selected a home delivery service for groceries, or ordered a taxicab from the main menu of options.

### CLAIM OF PRIORITY

This U.S. utility patent applications claims priority to related U.S. Provisional Application Serial No. 60/198,642 filed Apr. 20, 2000 and entitled “Systems and Methods for Connecting Customers to Merchants over a Voice Communication Network,” the contents of which are hereby incorporated by reference.

### FIELD OF THE INVENTION

This invention relates to methods and systems for employing a customer's voice communication device to present the customer with a list of available services and goods.

### SUMMARY OF THE INVENTION

The systems and methods described herein include systems capable of communication with a caller over a voice communication channel. For example, a caller using a cell phone may wish to have Chinese food delivered to an address by the time they complete their commute home from work. To this end, the systems described herein allow the customer to employ the phone to dial a toll-free number that connects them with a central server. The server operates a voice recognition process that presents the customer with a computer-generated voice menu of options—for example, grocery delivery, takeout food, taxicabs, or information services. The caller would then say “food”. They would then say the location of their home after being prompted by the server system. After hearing a list of food options, the caller may select a choice by saying for example “Chinese”. The system would then present them with a list of restaurants to choose from. The caller would say the name of the restaurant of their choice, and the system would then route the call directly to the restaurant. The caller could equally well have selected a home delivery service for groceries, or ordered a taxicab from the main menu of options.

Other systems according to the invention will, in part, be obvious, and, in part, be shown from the following description of the systems and methods shown herein.

This patent disclosure describes, inter alia, a system that uses Voice Recognition (VR) technology to automatically connect a caller on a cell phone or telephone to a vendor offering a service. Examples of vendors could include takeout food restaurants, taxicab services, and grocery home delivery services, etc.

### BRIEF DESCRIPTION OF THE FIGURES

A more complete understanding of the invention and many of the attendant advantages thereto will be readily appreciated as the same becomes better understood by reference to the following detailed description when considered in conjunction with the accompanying drawings, wherein like reference numerals refer to like parts and wherein:

FIG. 1 shows an embodiment in accordance with the invention of a system for connecting customers to merchants over a voice communication network.

FIG. 2 shows an embodiment of revenue model in accordance with the invention.

FIG. 3 shows an embodiment of dynamic menu tree in accordance with the invention.

### DETAILED DESCRIPTION OF THE ILLUSTRATED EMBODIMENTS

For the purposes of the discussion herein, customers can be understood to be any one or more person, entity, etc., that can otherwise act in a manner consistent with a customer as depicted herein. Additionally, product can be understood to include any and all products, services, etc., as is well-known across any and all industries. Furthermore, merchant can be understood to include any and all providers of products, as products are defined herein.

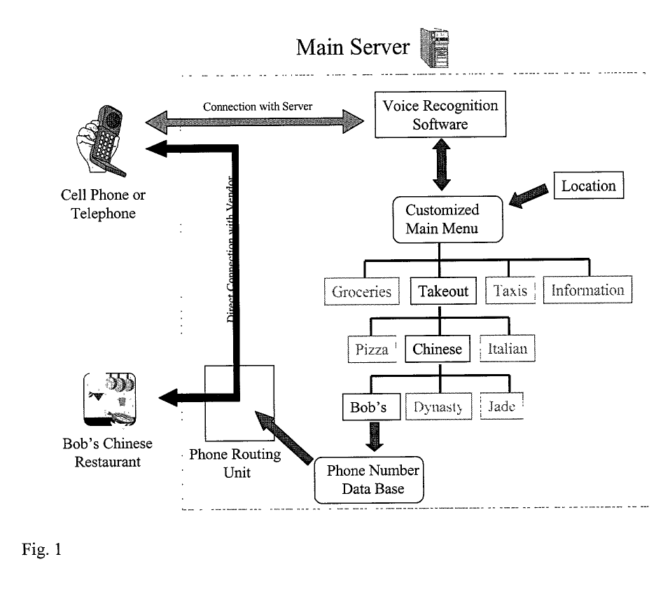

The operation of the system can be seen from the example that follows, by referring to FIG. 1:

A caller using a cell phone from a vehicle would like to have Chinese food delivered to their address by the time they complete their commute home from work. They press a button on their phone that speed-dials a toll-free number. This connects them with a central server on which VR software has been installed. They are presented with a computer-generated voice menu of options—for example, grocery delivery, takeout food, taxicabs, or information services. The caller would then say “food”. They would then say the location of their home after being prompted by the system. After hearing a list of food options, the caller would say “Chinese”. The system would then present them with a list of restaurants to choose from. The caller would say the name of the restaurant of their choice, and the system would then route the call directly to the restaurant. The caller could equally well have selected a home delivery service for groceries, or ordered a taxicab from the main menu of options.

Example Variations of the Systems and Services Described Herein

The Voice Recognition systems described herein is intended to encompass, although not be limited to, the variations listed below:

1. Incoming calls from the customer can be made from mobile wireless phones, or from private or public land-line telephones.

2. Transaction services provided to the caller could include restaurant information and reservations, ordering takeout food, ordering home delivery of groceries, or calling for a taxicab or other mode of transportation.

3. The caller could request information about a particular movie. Locations and show times would be listed in order of location, with the closest listed first. They could also be listed in chronological order, with the earliest showings listed first.

4. The caller could ask for a list of movies showing during a particular time period, and be given a list of cinema locations and exact show times.

5. A user could call for the closest movie theater, and be given the names of movies that are showing there and the show times.

6. A user could call to find out information about concerts or music performances. This information could include details of the performance, performance times, locations, and cost.

7. A user could call to determine a list of bars or other licensed premises that are open at any given time. These could be given in order, with the closest listed first.

8. A user could call to determine the location of the closest open hospital emergency room, clinic, doctor, or dentist at any given time.

9. Information provided to the caller could include stock quotes, weather reports and updates, traffic reports, driving directions, flight information, and train and bus schedules and information.

An Example Business Method

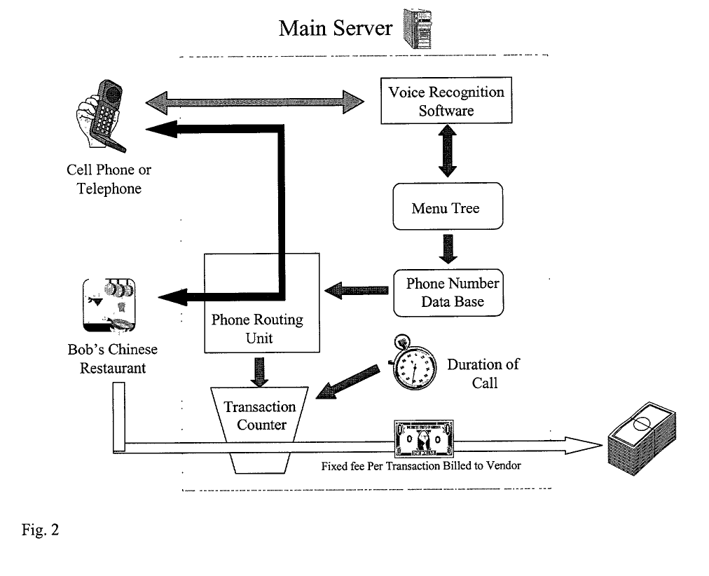

One revenue model is shown schematically in FIG. 2.

The invention can include a revenue model that provides free use to the customer, or caller. The call from the phone is a toll-free number, and no connection fee is charged to the customer when the call is transferred to the vendor. The vendor, however, is charged a fixed fee for every call connected via the system that results in a transaction. The transaction counter records separately the calls for each vendor that is successfully connected by the router unit to the vendor. If required, the duration of the call can also be timed, and only calls that are connected for longer than a minimum time period are counted as transaction calls. At the end of each billing cycle, all the vendors in the system database are billed for the total number of transaction calls that were made during the previous billing cycle.

Example Variations of the Revenue Model

The following methods of billing the vendors listed on the system are also intended to be covered by the disclosure, as are any combination of the methods:

1. A fixed fee per transaction call billed to the vendor each billing cycle (as described above).

2. A variable fee that is based on the volume of transaction calls in a given billing cycle. For example, the first block of calls could be charged at a certain rate, followed by a second block of calls charged at a different rate, and so on. This would include the option of offering a block of calls at no charge to the vendor.

3. A variable fee per transaction call that is determined by the time at which the call is made. For example, a certain time period (such as in the early evening) could be defined as a peak period, and calls made during this period could be billed at a higher fee per call than during off-peak time periods. This would also include the option of offering for free to the vendor calls made within a certain time period.

4. A variable fee per transaction call that is determined by the type of vendor, or the service being offered. For example, transaction calls for restaurants could be billed to the vendor at a different rate per transaction call than for a taxicab service.

5. A variable fee per transaction call that is determined by the location of the vendor. For example, vendors in certain areas of the city could be charged a higher transaction fee per call than vendors in other areas.

6. A fixed fee to be listed on the system, billed to the vendor per billing cycle. This could also be combined with any of the “per transaction call” billing schemes described in this disclosure, if desired.

7. A fixed listing fee billed to the vendor per billing cycle, the fee being determined by the position of the vendor's listing in the menu tree. For example, a vendor would be required to pay more to be listed higher up in the menu tree, where it would be expected to attract more listeners. This could also be combined with any of the “per transaction call” billing schemes described in this disclosure, if desired.

Filtered Menus

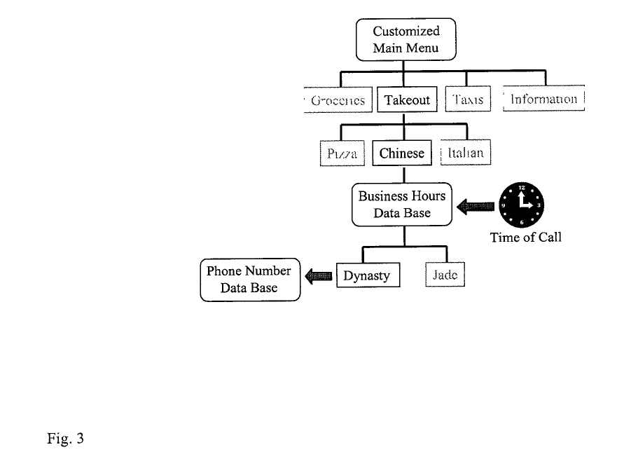

The invention may also employ a menu tree that is dynamic—that is, the menus presented to a caller can change depending on the time of the call (“time filtering”) or the location for which the service is requested (“location filtering”). Many other kinds of filters could be employed, such as only offering movie information or tickets for movies that have not sold out (“availability filtering”). The idea is illustrated in FIG. 3 for time filtering.

In FIG. 3, the caller has selected Chinese takeout food. The time of the incoming call is used to determine the Chinese takeout restaurants that are currently open for business, and only those restaurants are presented to the caller in the menu. Comparing FIGS. 1 and 3, it can be seen that only two of the three restaurants in the menu in FIG. 1 are included in the menu in FIG. 3.

Example Variations of the Filtered Menu

The following variations of the filtered menu scheme are also intended:

1. Utilizing a database whereby the identified menu content is dependent upon the time in which the call (i.e., request) is placed (“time filtering” as described above). For example, only restaurants open at the time of the call will be included.

2. Utilizing a database whereby the identified menu content is dependent upon the location requested by the caller (“location filtering” as described above). For example, only restaurants within a certain radius of the requested location will be included.

3. Utilizing a database whereby the identified menu content is dependent upon the availability of the product or service requested (“availability filtering”). For example, only movie showings with tickets still available would be included in the menu.

4. Utilizing a database whereby the method by which the menu entries included in the menu are determined by some filtering criteria. For example, a criterion for restaurants to be listed in the menu could be the current wait time for seating or the average price range of entrees, or the delivery time for takeout restaurants.

5. Utilizing a database whereby the order of the identified menu contents are presented is determined by some ordering criteria. For example, the order of listed restaurants in the menu could be from the shortest to the longest wait times for seating, or takeout restaurants could be listed in order of increasing delivery time.

6. Utilizing a database whereby caller (i.e., customer) can select the filtering or ordering criteria using a simple set of voice commands. The selection could include price range, wait time, delivery time, etc.

7. Utilizing a database wherein the system can prioritize the order in which entries occur in the menu, according to the frequency with which entries have been selected in a pre-determined past time period. For example, if Bob's Pizza is the most frequently selected option in the takeout menu over the last month, the system could automatically place that entry at the top of the takeout menu structure. The second most frequently selected option could be placed second in the menu, and so on.

8. Utilizing a database in which auto-location is used to determine the content of the menu structure. Auto-location determines the location of the caller from the location of the wireless cell site used to service the call. This information could be used to only include vendors or services within some predetermined radius of the caller, such as nearby restaurants or gas stations.

Note that any combination of the above variations of the filtered menu scheme are intended to be covered by the disclosure.

Tagged Messages

In order to demonstrate the value to the vendor that the system is providing to their business, a short audible message or “tag” can be sent to the vendor to indicate that the current phone call was initiated by the system. This tag could be in the form of a short audio clip that is played immediately after the vendor answers the phone, and just before the phone connection is completed between the caller and the vendor by the routing unit.

Certain Variations of Tagged Messages

1. A system in which a short audio clip is automatically sent to the vendor at the beginning of each call, to identify to the vendor that the call was connected through the system. This increases the awareness of the vendors to the value added by the system to their business.

2. A system in which a short advertising message is played to the user when they request a service or information. For example, when they request one of the information services, a short message could be played to the user telling them the source of the information.

3. A system in which a sponsor could pay to have a short advertising message played to the user when they request a service or information. For example, when they use the system, a short message could be played saying “this service brought to you by . . . ”.

4. A system in which a short audio clip is automatically sent to the caller at the end of each call, to thank the caller for their business.

5. A system in which an audio clip advertising the merits of being a listed vendor on the system is inserted at the beginning of any call placed through the system to non-listed vendors. For example, a caller could be connected to a vendor who is listed on an Internet directory page, but is not a listed vendor on the system. The advertising audio clip would be inserted at the beginning of the call, just before the caller is connected to the vendor.

Personalized Menus

A further embodiment of the invention could include a personalized “voice box” on the server, where each user could set up customized menus that include frequently called vendors conveniently located in the menu tree. In addition, menus that provide information such as weather, traffic conditions, and stock quotes could be customized by the user to provide the information in a more convenient and timely manner. The personalized voice box could be automatically entered using a caller ID system that identifies the caller, or it could be accessed using a password that is understood by the voice recognition software.

The personalized voice box could also be used to perform Voice Activated Dialing (VAD). The user could set up a list of frequently called numbers, with a name associated with each number. To call the number, the user would just say the name associated with the number, and the system would dial and connect the call automatically for them.

The user would be able to customize their voice box through the phone using voice commands or the touch tone buttons on the phone, or they would have the option to conveniently customize the voice box by going to the system web page. From the web page, they would be able to customize all their options, including their voice menus and VAD caller lists.

Variations of Personalized Menus

1. A method or system in which the caller can personalize the menu structure presented to them when they call. For example, the options, and the order in which the options are presented, and the entries included in each option could be customized by the caller. The system could recognize the caller either by the use of a password, or by using a caller ID system.

2. A method or system in which the user can create multiple customized menu trees. Each menu has a customized name or label. The menu tree to be used for any given call could be selected by saying the desired tree name.

3. A method or system in which the user can create a list of frequently called numbers in a personalized voice box on the system. In order to call the number, the user says the name associated with the number, and the system can automatically dial and connect the call for the user (Voice Activated Dialing—VAD).

4. A method or system in which the user can customize their personalized voice box by going to the system web page. From the web page, they can change their menu options and set up their VAD caller lists.

The above description of the illustrated embodiments is provided merely to allow one of ordinary skill in the art. Accordingly, although FIGS. 1 through 3 graphically depict the elements of the systems as functional block elements, it will be apparent to one of ordinary skill in the art that these elements can be realized as computer programs or portions of computer programs that are capable of running on a data processor platform to thereby configure the data processor as a system according to the invention. As discussed above, the systems described herein can be realized as a software component operating on a conventional data processing system such as a Unix workstation. In that embodiment, the systems described herein may be implemented as a C language computer program, or a computer program written in any high level language including C++, Fortran, Java or basic. General techniques for high level programming are known, and set forth in, for example, Stephen G. Kochan, Programming in C, Hayden Publishing (1983).

Those skilled in the art will know or be able to ascertain using no more than routine experimentation, many equivalents to the embodiments and practices described herein. Accordingly, it will be understood that the invention is not to be limited to the embodiments disclosed herein, but is to be understood from the following claims, which are to be interpreted as broadly as allowed under the law.

What is claimed is:

1. A system for connecting customers to merchants, comprising,
a database having products arranged by product category, the products also being associated with at least one merchant;
a voice recognition system for navigating the database by product category, and,
at least one telephonic communications link to the voice recognition system to allow the customer to navigate the database and select a product.

2. A system according to claim 1, wherein the at least one telephonic communications link further includes a link to the at least one merchant associated with the selected product.

3. A system according to claim 1, further comprising at least one distinct second telephonic communications link to the at least one merchant associated with the selected product.

4. A system according to claim 1, further including a personalized voice box that includes the consumer's voice command preferences.

5. A system according to claim 1, further including a database having at least one of merchant phone numbers, merchant addresses, and merchant email addresses.

6. A system according to claim 1, further including a database of customer phone numbers.

7. A system according to claim 1, further including a system for filtering the database based upon at least one of the time of day, the customer location, and availability of product.

8. A method for connecting customers to merchants, comprising,
providing a database having products arranged by product category, the products also being associated with at least one merchant;
providing a voice recognition system for navigating the database by product category, and,
providing at least one telephonic communications link to the voice recognition system to allow the customer to navigate the database and select a product.

9. A method according to claim 8, further comprising utilizing the telephone communications link to contact a merchant associated with the selected product.

10. A method according to claim 8, further comprising providing a system to filter the database based on at least one of time, customer location, and product availability.

11. A method according to claim 8, further comprising providing an advertisement on the telephonic communications link.

12. A method according to claim 8, further comprising providing a personalized voice box that includes the customer's preferences.

13. A method according to claim 8, further including providing a database having at least one of merchant phone numbers, merchant addresses, and merchant email addresses.

14. A method according to claim 8, further including providing a database of customer phone numbers.

15. A method according to claim 8, further comprising providing at least one distinct second telephonic communications link to the at least one merchant associated with the selected product.
